(19) United States
(12) Patent Application Publication
(10) Pub. No.: US 2010/0326061 A1
(43) Pub. Date: Dec. 30, 2010

(54) "Buruga" hydraulic vehicle engine

(76) Inventor: Gabriel Emil Buruga, Anaheim, CA (US)

Correspondence Address: Christopher N. Buruga, 1521 W. Harle Pl., Anaheim, CA, 92802, US

(21) Appl. No.: 12/456,862

(22) Filed: Jun. 24, 2009

(51) Int. Cl. F15B 11/00

(52) U.S. Cl. 60/325

(57) ABSTRACT

This new type of vehicle engine is a zero emission engine. It uses low consumption of electric power from electric batteries, which is transformed in hydraulic power through the hydraulic pumps system, which is transformed in mechanical power through the cylinders of the engine.

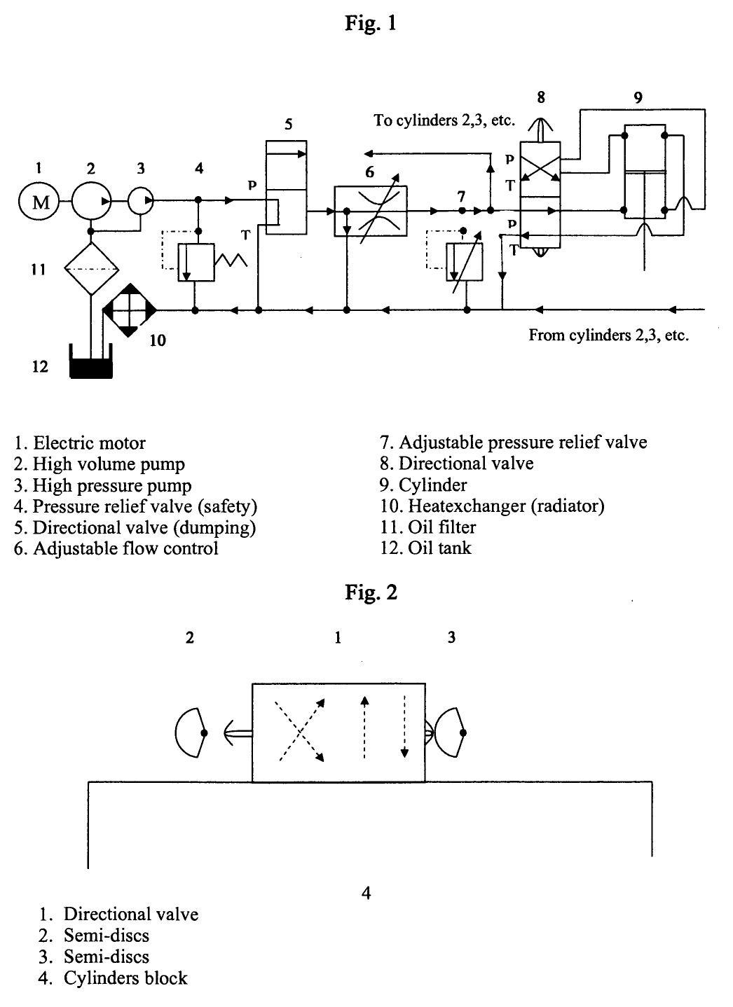

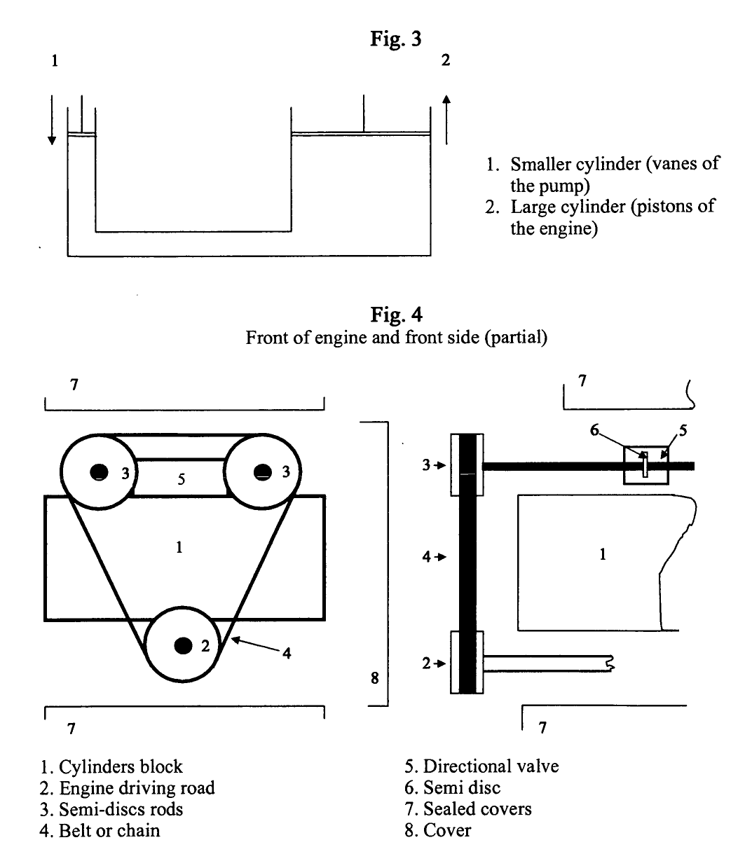

The engine develops a great mechanical force based on the fact that electrical force is multiplied by hydraulic force and the fact that liquids do not compress when a mechanical force is applied on.

This engine works with hydraulic pistons driven by a high volume hydraulic pump and a high pressure hydraulic pump. These pumps are activated by a DC electric motor. The DC electric motor gets the power from 1 or 2 electric batteries. This type of engine does not make any pollution, being a zero emission car engine.

The figure number 1 shows how a piston works.

The DC electric motor is a low power type. The estimated power might be in between 3 to 10 HP, depending of the size and weight of the car. The same are the hydraulic pumps. The gal/min ratio and the PSI of the pumps are proportional with the size of the car.

The hydraulic system is equipped with a safety pressure valve. An adjustable valve regulates the volume and the pressure of the hydraulic oil to obtain more speed and power for acceleration. The same thing can be obtained by adjusting the RPM of the DC electric motor. Both systems can work independently or in parallel. The oil pressure goes through a directional valve to the cylinder. This directional valve is mechanically activated by a system which corresponds with the position of the piston in the cylinder. When oil pressure goes on top of the cylinder through the side superior port, the side inferior port is connected to the tank and releases the pressure underneath the piston, which moves down. When the oil pressure goes to the bottom of the cylinder through the inferior side port, the superior port is connected to the tank, releasing the pressure on top of the piston. In this mode the piston creates mechanical power when it moves in both directions. The stroke of the piston is between below of the superior side port and above the inferior side port, the oil pressure having a better access to the whole surface of the piston. To achive more speed, the stroke of the piston has to be as short as possible in accordance with the size of the main driving rod of the engine.

When the engine is in the idle mode, the dumping valve is activated and the oil from the pumps goes back in to the oil tank.

Figure number 2 shows the system which activates the directional valve according with the position of the piston. The mechanical directional valve is activated by two rods with semi-discs.

A hydraulic engine with 3 cylinders could be the most popular engine because the rotation created is uniform and smooth. The power of the engine can be modified by changing the diameter of the cylinders and the size of the electric motor, with proportional hydraulic pumps.

Figure number 3 shows the physical law which applies in creating more power of the hydraulic engine in comparison with electrical power used.

If a pressure is applied by a piston (in this case the vanes of the hydraulic pumps) into a cylinder which comunicates with a larger cylinder, the applied power is amplified by the ratio of the size of the receiving cylinder (the larger one) divided by the size of the smaller cylinder. If the smaller cylinder has a diameter by 1″ (size of a vane) and the larger cylinder has 10″, the power obtained on the larger is multiplied by 10 then the power applied in the smaller cylinder.

Examples: Manual hydraulic jack for lifting a car to fix a flat tire. A person can lift a car using the jack with one hand, without effort. In an auto repair shop the cars and trucks are lifted high above ground with two cylinders activated hydraulic by a small electric motor (most cases by 1 HP) with a small hydraulic pump. The cars and trucks are lifted but, for pushing a car or a truck on wheels, less power is required.

With a 3 cylinder hydraulic engine the position of the pistons are at 120 degrees of the circle from each other. In this mode the driving rod rotates easy and smooth. The multiplying power factor of rapport of the size of the cylinders will be multiplied again with 3 because the pistons work in both directions.

Figure number 4 shows how a directional valve for 1 cylinder is activated mechanically by 2 rods with semi-circles discs, positioned corresponding with the position of the piston in the cylinder. With a three cylinders motor, the semi-circles mounted on those 2 rods have to be the same as the position of the pistons of the other cylinders, at 120 degrees of the circle from each other. Each cylinder has it's own directional valve which is activated in accordance with the position of it's own piston.

The whole assembly is sealed and inside, the returning oil to the tank goes around all movable parts of the hydraulic engine, for lubrication. The engine doesn't need lubrication oil. The returning oil goes back to the tank through a heat-exchanger, used also for heating the inside of the car, if needed. The hydraulic oil is cooled down by air. The temperature of hydraulic oil will never reach high temperatures, even if it's cooled by the air. The temperature of the oil can be controlled by the amount of oil used (capacity of the tank) and by an additional radiator, if needed. This engine does not require a cooling fluid with pumps and sophisticated labor in building the block of the engine (no cooling channels through the engine block). The engine requires a low amount of hydraulic oil, proportional with the capacity of the cylinders.

The electric motor gets it's own power from 2 (or 1) electric batteries type lithium-ion or newer types. The engine is equipped with a recharge generator. If the car is equipped with 2 batteries, as long as one battery is used, the other can be recharged by the generator. When the battery in use is empty, an electronic device will connect the second battery to the motor and connect the empty one to the generator. Of course, a full charge will not be obtained using the generator, but will create more electrical power while the car is running. The full charge of the batteries is obtained by plugging a fast charger, with which the car is equipped, into any 110/120V (or 220V) outlet. The car can be equipped even with only one battery.

The gear box of a regular car does not need modifications, only if you need to simplify it.

Advantages of “Buruga” Hydraulic Vehicle Engine
No pollution, no exhaust.
The engine can cover over 500 miles with one charge.
No danger of explosion of the fuel in case of an accident.
The size and weight of the vehicle is not essential, due to the hydraulic power.
Does not require lubrication fluid.
The hydraulic oil can be changed, based on the usage of the car, on a yearly basis. Hydraulic oil is very cheap and the engine needs only a few gallons of oil.
Does not require cooling fluids and a cooling system.
Does not require sophisticated systems such as an ignition system or injection system, etc.
Due to the fact that electrical power is multiplied by hydraulic power, a car equipped with a hydraulic engine will cover a lot more milage then an electrical car equipped with the same electrical battery. The rapport between the milage covered by an electric car and a car with a hydraulic engine might be at least 25 times more in favor of the car equipped with a hydraulic engine.
The hydraulic engine develops a high torque force.
The total cost of the engine is a lot cheaper then that of the engine of a regular car. The price of a hydraulic engine car has to be a lot less than an electric car.
The gear box can be a simple gear box with 1, 2, or 3 gears, plus the reverse gear. The existing gear boxes installed already on regular cars can be used.
etc.

1. “Buruga” Hydraulic Vehicle Engine patent, or part of it, to be protected against of any kind of use or any kind of copy without the accept and confirmation of the inventors.
